(19) United States
(12) Patent Application Publication
(10) Pub. No.: US 2009/0016843 A1
(43) Pub. Date: Jan. 15, 2009

(54) Spacer Assemblies, Apparatus and Methods of Supporting Hardware

(76) Inventors: Igor Komsitsky, Los Angeles, CA (US); Javier Torres, Hacienda Heights, CA (US); Terrence Csik, Pasadena, CA (US)

Correspondence Address: HENRICKS SLAVIN AND HOLMES LLP;SUITE 200, 840 APOLLO STREET, EL SEGUNDO, CA, 90245, US

(21) Appl. No.: 11/777,285

(22) Filed: Jul. 13, 2007

(51) Int. Cl. F16B 1/02

(52) U.S. Cl. 411/105; 248/220.21; 414/809

(57) ABSTRACT

Light-weight fastener assemblies, spacers, standoff and other fastener components include one or more non-metal parts. A non-metal spacer can support a fastener element or fastener support so they fastener and a payload can be supported spaced apart from a surface such as an aircraft surface.

### BACKGROUND

1. Field

This relates to fasteners, fastener components and spacers or stand off components for use with fastener assemblies and their methods of manufacture and use.

2. Related Art

Fasteners are used in a number of applications, for example on aircraft, to position and secure hardware. For example, fasteners may be used to position and secure equipment, housings, cables and wiring and conduit. Fastener assemblies known as spacers or standoffs position a payload a pre-determined distance from an underlying support or substrate surface or from an overlying surface spaced apart from the support to which the spacer is mounted. For example, a payload may be spaced from an adjacent surface for thermal or electromagnetic shielding, reduced vibration, or other reasons.

Fastener spacer assemblies include a housing to be mounted to a substrate surface and a fastener element through which the payload will be secured. The assemblies are typically all metal components having a significant weight, for example, for purposes of strength and durability. In aircraft applications, the types and number of fasteners having metal components add significant weight to the final assembly. If the weight of a given part could be reduced, even small weight reductions in an individual component may add up to a significant weight reduction overall. Additionally, metal components may be subject to corrosion and material compatibility issues.

### SUMMARY

Apparatus and methods are described for providing light-weight fastener assemblies, for example spacers, stand-offs and other fastener components, and such components that may have improved corrosion resistance and compatibility with adjacent materials when in use. Light-weight fastener assemblies having significant strength can be formed from light-weight materials. The disclosed fastener assemblies can also be used to provide a final construction or manufacture such as an aircraft with an otherwise lighter weight compared to those constructed with existing fastener assemblies.

In one example of a fastener assembly, for example one that can be used on aircraft, the fastener assembly includes a non-metal mounting surface for mounting the assembly to a support surface or a substrate surface. Example surfaces include panels, framing, bulkheads, engine components and accessories, as well as a number of aircraft components. The fastener assembly also includes a non-metal body extending from the mounting surface and a support above the spacer body for supporting a fastener element. The fastener element to be supported by the support would cooperate with a complementary fastener element, for example one that would be used to support and secure a payload on the fastener assembly. As used herein, a payload may be equipment, housings, cables, conduit, wiring, instruments, fluid flow lines, as well as other items to be mounted and/or secured to a support surface. In one example, the support can accommodate a bolt, stud, nut, coil or other suitable component that will receive a complementary component to secure the payload.

In another example of a fastener assembly, the fastener assembly includes a non-metal mounting surface for mounting the assembly to a substrate. In one example, the fastener assembly can be a spacer or standoff or similar assembly. The assembly also includes a non-metal spacer body extending in a first direction from the mounting surface, and a fastener support above the spacer body. In one example, the fastener support is also non-metal. A fastener element is fixed and embedded in the fastener support above the spacer body. In one example, no fastener element extends through the spacer body to the mounting surface, so that no part of the spacer body or interior of the spacer body is metal. In a further example, the fastener element is a bolt, and the bolt may have a hex head or other shaped head configuration embedded in the support, and in another example the fastener element is a nut embedded in the support. The fastener element may include rotation-limiting elements, for example serrations, non-circular configurations, for example square, rectangular, octagonal, and other polygonal shaped surfaces, as well as non-uniform shapes, one or more spars or other projections, surface discontinuities, for example knurling, or other elements or configurations to prevent or limit rotation. Additionally, the fastener assembly may include reinforcing walls between the body and the mounting surface, and a reinforcing element, for example a reinforcing wall, may include a concave surface, walls extending on each side of a fastener opening through the mounting surface used to mount the assembly to the substrate, as well as other configurations. In a further example, the spacer body includes an outer wall, which may be cylindrical or other configurations described herein, and reinforcing elements may extend from the outer wall to the mounting surface. The outer wall may be triangular, square, pentagonal, hexagonal or other polygonal shape, or it may be other than polygonal. In an additional example, the fastener element is engaging the fastener support through a relatively small portion of the overall axial length of the fastener assembly. For example, engagement between the fastener element and the fastener support may be less than approximately 50 percent of the overall axial length of the fastener assembly, and in another example may be less than approximately 25 percent of the overall axial length.

In another example of a fastener assembly such as any of the combinations described in the immediately preceding paragraph, the spacer body may include one or more bores, cavities or recesses inside the spacer body. In one example, a bore can extend co-axial with a central axis of the fastener assembly. In another example, the coaxial bore is the only bore in the spacer body. In a further example, a plurality of bores can extend in the spacer body. The bores can be the same or different lengths, the same or different shapes and the same or different sizes. Multiple bores can be distributed substantially uniformly about a central axis of the spacer body, or distributed non-uniformly, for example to account for expected loading on the part.

In a further example of a fastener assembly, including any of the previously described combinations, a spacer, for example for mounting on an aircraft surface, includes a non-metal support surface for supporting the spacer on the aircraft surface, and a non-metal spacer body extending away from the support surface. At least one reinforcing wall extends between the body and the support surface. A support for a fastener element extends on a side of the body opposite the support surface, and a fastener element is received in the support. The fastener element in turn receives a complementary fastener element. In one example, the support surface is substantially planar, and may include a first wall defining an opening for receiving a fastener for fixing the fastener assembly to the aircraft surface. A second wall defining a second opening may also receive a fastener for helping to fix the fastener assembly to the aircraft surface. In another example, the spacer body is substantially circular but may have other configurations (including those described herein) and may include a bore, for example a bore coaxial with an axis of the spacer. Additionally, or instead, one or more bores may extend within the spacer body having respective central axes spaced apart from a central axis of the spacer. A bore can extend from the support through the spacer body and through the support surface. A counter bore may extend through the support surface and a portion of the spacer body.

Another example of a spacer according to one or more of the combinations described in the immediately preceding paragraph has the reinforcing wall or element with a concave surface, which may be substantially a semi circle. A portion of the reinforcing element may extend along an edge of the support surface, and the reinforcing element may include portions extending along opposite edges of the support surface. A portion of the reinforcing element may also extend about part of a fastener used to help in securing the support surface to the aircraft surface. Another reinforcement element may extend on another side of the spacer separated from the first reinforcing element. The additional reinforcement element may also extend from the spacer body to the support surface. The additional reinforcement element may have a configuration identical to that of the first reinforcing wall or element.

In another example of a fastener assembly, the assembly may include a non-metal support surface for supporting the fastener assembly on an aircraft surface, and a non-metal body extending from the support surface. A reinforcement element extends between the body and the support surface. A flexible securement is supported on the body and has first and second portions that can be secured to each other, for example to form a closed loop. The reinforcement element can include a wall extending on each side of a fastener used to help secure the support surface to the aircraft surface. In one example, the walls can help to define a semi circular or concave surface extending around a portion of the fastener.

In a further example of a fastener assembly, including any of the combinations described in the immediately preceding paragraph, the body may support a saddle wherein a first flexible securement element extends from a first portion of the saddle and a second securement element extends from a second portion of the saddle. The first flexible securement and the second securement elements may extend from opposite sides of the saddle. The first and second securement elements may extend to respective ends having complementary engagement elements. The engagement elements may be combined to form a closed loop. Examples of securements include clamps, for example D-clamps and hinged D-clamps, brackets for example S-brackets and L-brackets, line supports and line support blocks, and other securements, including those described herein. One or more portions or all of the fastener assembly may be formed from non-metal materials, including plastic, structural plastics, and similar materials, including polyamide imides. In another example, the body has a rectangular cross-section, and includes one or more axial extending cavities, recesses or bores. Such cavities, recesses or bores may extend axially of the assembly, and may take the configuration of any of the cavities, recesses or bores described herein. They may be a single element, a bore and counter bore, multiple elements, or multiple shapes forming a single cavity. They may have a closed-end, such as opposite the support surface, and one or more of them may open at the support surface. The complementary engagement elements may include in part spaced apart projections and an engagement surface for engaging the spaced apart projections. These engagements components allow the assembly to support a number of payload sizes.

In a method of assembly of components for a construction, a fastener assembly is mounted to a substrate by mounting a body to the substrate through fasteners, adhesive, bonding material or other mounting material and a support surface between the body and the substrate. A first fastener element is supported by the body, such as a fastener support on the body spaced from the support surface. A payload may be positioned on the fastener element and secured to it with a complementary fastener element engaging the first fastener element. The payload may be supported by multiple fastener assemblies by placing the payload across multiple fastener elements, followed by securing the payload on the multiple fastener assemblies with respective complementary second fastener elements. In one example, the first fastener element may be a stud or bolt and the complementary fastener element may be a nut or other threaded element. In another example, the first fastener element may be a nut or other female receptacle and the second fastener element may be a bolt, threaded shaft or other complementary threaded element. In another example, the fastener elements may be interlocking elements, such as cam locking elements, pin locking elements and the like. In a further example, the first and second fastener elements may be part of a combination that can be combined to form a closed loop or other encircling configuration. The combination may be a flexible combination. In further examples, the payload may be preassembled with fastener elements complimentary to those on the body, and the payload placed on the bodies. The payload then can be secured by securing the respective fasteners. The payload can be placed on multiple bodies before a fastener is secured or the payload can be placed on a first body and secured by securing the respective fastener before the payload is placed on the next body. Preassembly can save assembly time, and makes assembly of the combination easier.

These and other examples are set forth more fully below in conjunction with drawings, a brief description of which follows.

### BRIEF DESCRIPTION OF THE DRAWINGS

FIG. 1 is a side elevation view of a fastener spacer assembly supported on a surface and in turn supporting a payload.

FIG. 2 is an upper isometric view of one example of a fastener spacer assembly in the form of a male spacer.

FIG. 3 is a top plan view of the spacer of FIG. 2.

FIG. 3A is a vertical section of an insert or eyelet for use in a spacer;

FIG. 4 is a bottom plan view of the spacer of FIG. 2.

FIG. 5 is a bottom isometric view of the spacer of FIG. 2.

FIG. 6 is a front elevation view of the spacer of FIG. 2.

FIG. 7 is a longitudinal section view of the spacer of FIG. 2 taken along the Line 7-7 of FIG.3.

FIG. 8 is a side elevation view of the spacer of FIG. 2.

FIG. 9 is a transverse section view of the spacer of FIG. 2 taken along the Line 9-9 of FIG.3.

FIG. 10 is a longitudinal section view of the spacer of FIG. 2 similar to that of FIG. 7 omitting a fastener element.

FIG. 11 is that transverse section view of the spacer of FIG. 2 similar to that of FIG. 9 omitting a fastener element.

FIG. 12 is a bottom isometric view of another example of a fastener spacer assembly in the form of a female spacer.

FIG. 13 is a top plan view of the spacer of FIG. 12.

FIG. 14 is a longitudinal section view of the fastener spacer assembly of FIG. 12 taken along Line 14-14 of FIG. 13.

FIG. 14A is a vertical section of the fastener spacer assembly of FIG. 12 taken along Line 14A-14A of FIG. 13.

FIG. 15 is a bottom plan view of a third example of a fastener spacer assembly in the form of a male spacer.

FIG. 16 is a longitudinal section view of the fastener spacer assembly of FIG. 15 taken along the Line 15-15.

FIG. 17 is an upper isometric of a helicoil insert for use in fastener spacer assemblies such as those shown in FIGS. 12-14 and 18-20.

FIG. 18 is an upper isometric view of a third example of a fastener spacer assembly in the form of a female spacer.

FIG. 19 is a top plan view of the fastener spacer assembly of FIG. 18.

FIG. 20 is a longitudinal section view of the fastener of FIG. 18 taken along the Line 20-20 in FIG. 19.

FIG. 21 is an upper isometric view of a fourth example of a fastener spacer assembly in the form of a clamp and spacer.

FIG. 22 is a front elevation view of the fastener spacer assembly of FIG. 21.

FIG. 23 is a front longitudinal cross-section view of the fastener spacer assembly of FIG. 21.

FIG. 24 is a side elevation view of the fastener spacer assembly of FIG. 21.

FIG. 25 is a transverse cross-section view of the fastener spacer assembly of FIG. 21.

FIG. 26 is a bottom isometric view of the fastener spacer assembly of FIG. 21.

FIG. 27 is a bottom plan view of a mounting element of the fastener assembly of FIG. 21.

FIG. 28 is a side elevation view of the fastener spacer assembly of FIG. 21 supporting a payload on a substrate surface.

FIG. 29 is a side elevation view of a portion of the fastener spacer assembly of FIG. 21.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of fastener assemblies and of methods of making and using the fastener assemblies are described. Depending on what feature or features are incorporated in a given structure or a given method, benefits can be achieved in the structure or the method. For example, fastener assemblies using structural plastics may achieve weight reductions in complete manufactures, such as for aircraft. They may also provide configurations that are stronger and easier to use, have improved corrosion resistance and material compatibility characteristics.

These and other benefits will become more apparent with consideration of the description of the examples herein. However, it should be understood that not all of the benefits or features discussed with respect to a particular example must be incorporated into a fastener assembly, component or method in order to achieve one or more benefits contemplated by these examples. Additionally, it should be understood that features of the examples can be incorporated into fastener assemblies, a component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of fastener assemblies and of methods of making and using the fastener assemblies are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

It should be understood that terminology used for orientation, such as front, rear, side, left and right, upper and lower, and the like, are used herein merely for ease of understanding and reference, and are not used as exclusive terms for the structures being described and illustrated.

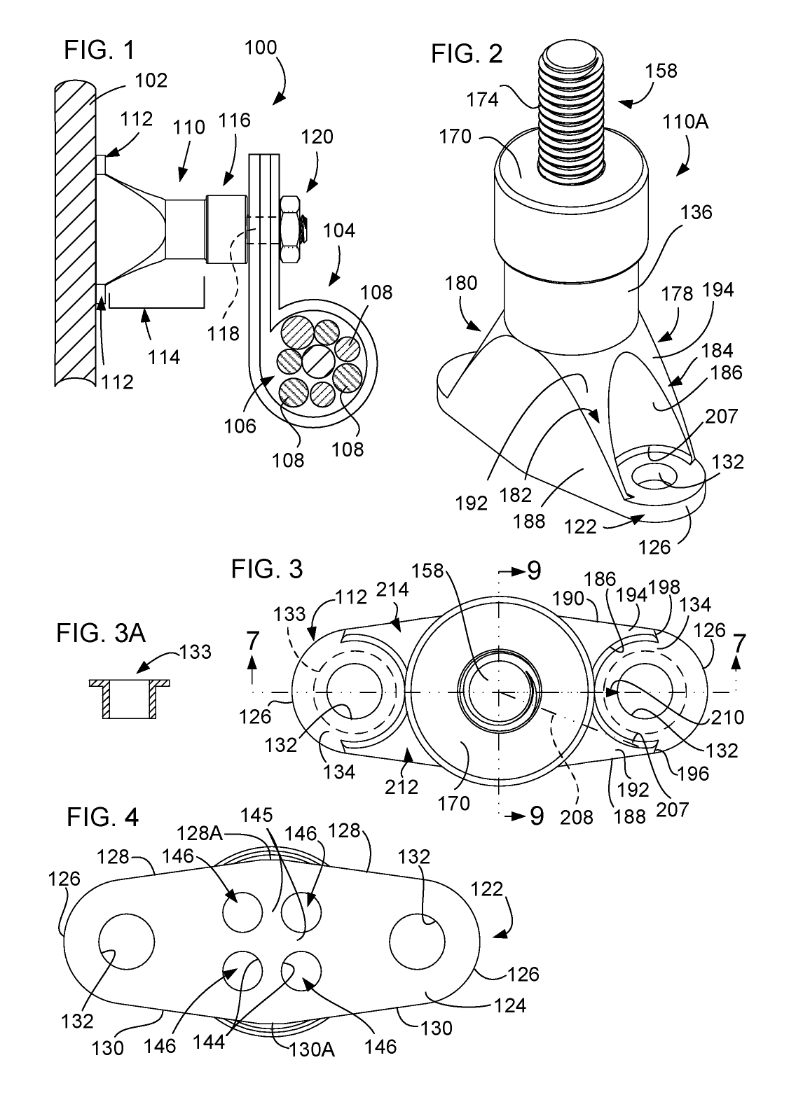

In one or more of the following examples, apparatus and methods are described for providing light-weight fastener assemblies, spacers, standoffs and other fastener components, and they may provide overall weight reductions for complex manufactures such as aircraft, improved corrosion resistance and material compatibility. In one example (FIG. 1), a fastener assembly 100 can be mounted to a support surface 102. The support surface 102 can be a substrate surface, a panel, a bulkhead, frame, or other support surface. An example of a suitable support surface 102 is an aircraft frame or other aircraft structure with which such fastener assemblies may be used. The fastener assembly 100 supports a payload 104. The payload is supported and secured relative to the panel 102 so as to be spaced from the panel and held substantially securely in place. In many uses of the present fastener assembly, multiple such fastener assemblies are used in the manner described herein to support a payload from a number of locations, but the present discussion will consider a single fastener assembly. The payload can be a number of items, including a bundle 106 of conductors 108. The bundle extends between two or more points, supported and secured to the underlying support panel along the way by multiple fastener assemblies 100.

In the example of the fastener assembly shown in FIG. 1, the fastener assembly 100 includes a spacer 110 having a mounting surface or mounting element 112 for mounting the spacer 110 to the panel 102. The spacer includes a spacer body 114 extending in a first direction, such as axially, from the mounting surface 112. In one example, the mounting surface 112 and the body 114 are formed from non-metal material. The spacer 110 includes a fastener support 116 on a side of the spacer body 114 opposite the mounting surface 112. The support 116 receives a fastener element 118. In one example, the fastener element 118 is fixed and embedded in the fastener support. As described in more detail below, the fastener element 118 is fixed so as to be positioned above the spacer body 114. In one example, the fastener element 118 is a bolt or a stud element, and in another example, a nut or other female receptacle can be fixed in the support 116. Other elements can be fixed on the support 116 as appropriate for forming a fastener assembly. In one example, no fastener element extends through the spacer body to the mounting surface 112. For example, the fastener element extends no lower than the upper 50 percent of the spacer, and in another example the fastener element extends no lower than the upper 25 percent of the spacer.

The fastener assembly 100 has the fastener element 118 extending beyond the end of the support 116. The portion of the fastener element 118 extending beyond the support 116 is configured to receive, engage with or otherwise cooperate with a complementary fastener element 120, which in the configuration shown in FIG. 1 is a hex nut threaded on the fastener element 118. Other combinations of components can be used to form the fastener assembly 100, including those described more fully below. The example of FIG. 1 and other configurations of a fastener assembly can be used to support the payload such as 104 shown in FIG. 1.

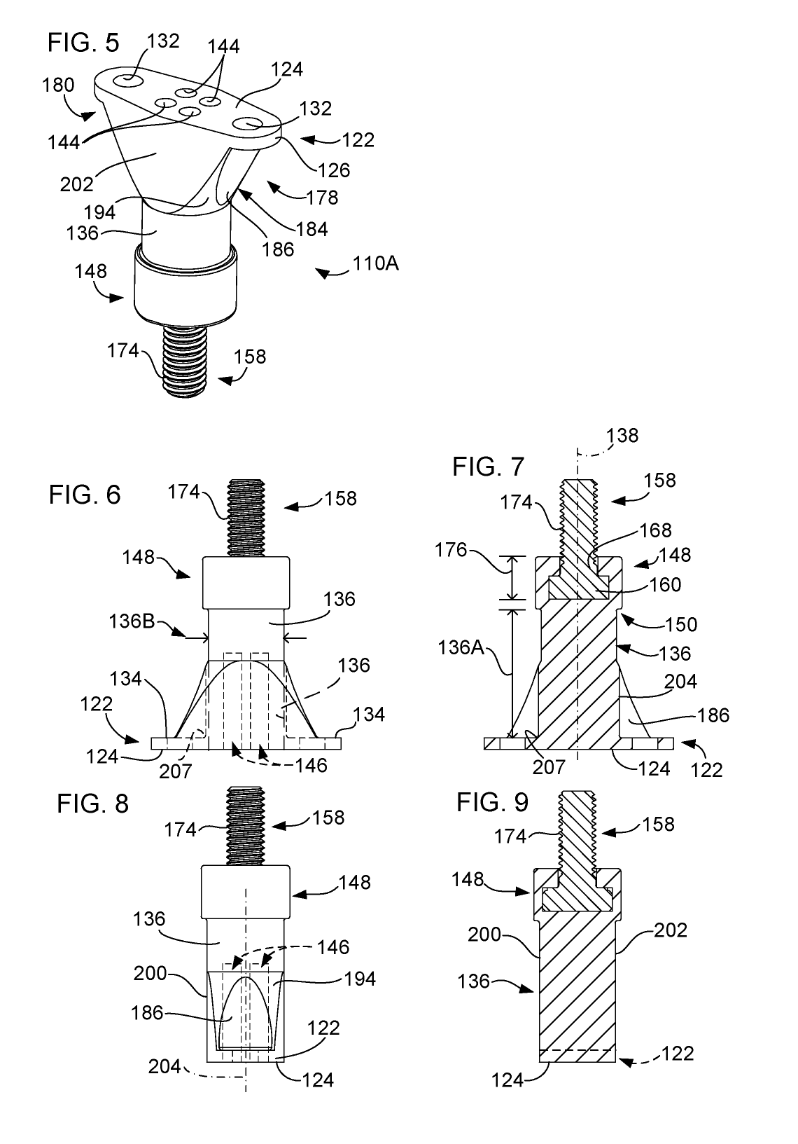

Several examples of spacers will be described that can be used with fastener assemblies. In one example (FIGS. 2-11), a spacer 110A, similar to the spacer 110 shown in FIG. 1, includes a non-metal mounting surface 122. The mounting surface 122 is a substantially planar base for the spacer 110A, and has a lower surface 124 (FIG. 4) that may be designed or configured to conform to the underlying support surface configuration. For example, where the support surface 102 is a substantially flat planar panel, lower surface 124 is also substantially flat. In the example shown in FIGS. 2-11, the mounting surface 122 has an outer perimeter approximating an ellipse, with ends 126 partially semi circular (FIGS. 3-4) and respective pairs of side walls 128 and 130 (FIG. 4), wherein the side walls in each pair are substantially straight and intersect at respective end portions 128A and 130A.

The mounting surface 122 includes a plurality of walls 132 defining respective openings for receiving fasteners (not shown) for fixing the mounting surface and therefore the fastener assembly to the support surface 102. The fasteners may be rivets, threaded fasteners, pins or other hardware. Other fixing means can be used, such as bonding agents, adhesives, and other materials for helping to fix the mounting surface 122 to the support surface 102. In the examples of bonding agents or adhesives that might be flowable, such material may extend into the openings (walls 132), may extend over the upper edges of the walls 132, and may also extend over part or all of the upper surfaces 134. Contact of the material with the adjacent surface(s) of the spacer help to hold the spacer in place. Engagement between the material and the adjacent edges of the spacer help to hold the spacer in place. Eyelets 133 (FIG. 3A) may be used in or around the openings to help resist loading forces that may be experienced through the spacer when held in place through the mounting fasteners. The upper surface 134 of the mounting surface 122 is substantially flat, but other surface configurations can be used.

A spacer body 136 is formed as part of, integral with, mounted to or otherwise fixed to the upper surface 134 of the mounting surface 122. The body extends in a first direction such as that defined by the central axis 138 (FIG. 7) away from the upper surface 134. The spacer body 136 spaces the fastener element (for example, 118 shown in FIG. 1) from the support surface 10 102 an amount according to the desired configuration for the final payload position. The spacer body extends a distance 136A away from the upper surface 134 and has a diameter 136B (FIGS. 6 and 7). In the example shown in FIGS. 2-11, no portion of the fastener element extends into the spacer body 136. Therefore, no part of the spacer body encloses the fastener element. The spacer body supports the fastener element and spaces the fastener element away from the support surface 102. Consequently, the spacer body supports the payload and spaces the payload away from the support surface 102. The outer exposed surface of the spacer body 136 may be substantially right circular cylindrical or other configurations such as those described herein.

The spacer body 136 may be solid, as shown in the example of FIGS. 2-11, but in the examples shown in FIGS. 12-14 and 18-20 described more fully below, the spacer body may include one or more cavities, recesses or bores within or extending through the spacer body. In those examples, the spacer body includes a first internal wall 140 defining a first bore 142. The first bore 142 may extend from an upper portion or upper end to an approximate mid portion of the spacer body, but in another example described herein, the bore may extend the entire length axially of the spacer body 136.

In the example shown in FIGS. 2-11, the spacer body 136 includes a plurality of walls 144 defining a respective plurality of bores 146 extending from a first location along the length of the spacer body to the opposite end of the spacer body, and in the present example through the mounting surface 122. Each of the bores 146 have respective central axes (not shown) extending parallel to the central axis 138, and the bores 146 are distributed in pairs or evenly about the central axis 138. The bores are also arranged in this example to have their centers positioned on an “X” configuration in the mounting surface or mounting element, rather than on the major and minor axes of the elliptical mounting element, which having their centers on the major and minor axes is another possible configuration. The distribution of multiple bores can have other configurations, and may depend for example on the expected loading, the number of bores, their length, their individual configurations relative to each other, and other factors. From either of the major or minor axes, the bore centers are located at 45 degrees, 135 degrees, 225 degrees, and 315 degrees, respectively. While the bore centers can be arranged otherwise, the “X” arrangement allows weight reduction while providing strength in the spacer body through the ribs or walls 145 separating adjacent bores (FIG. 4). The bores 146 are substantially right circular cylindrical. The first bore and the plurality of bores form cavities without any material, and produce a lighter-weight spacer body. Where the spacer is a molded part, the pluralities of bores are easily formed in part of the spacer body and through the mounting surface 126. Number of bores can range from a single bore to multiple bores the number of which may be based on the bore sizes and the cross-sectional area of the spacer body. The lengths of the bores can range as a function of the spacer body's overall length, and they can be identical to each other or different. The diameters of the bores can also range as a function of the spacer body's size, as well as the wall thicknesses.

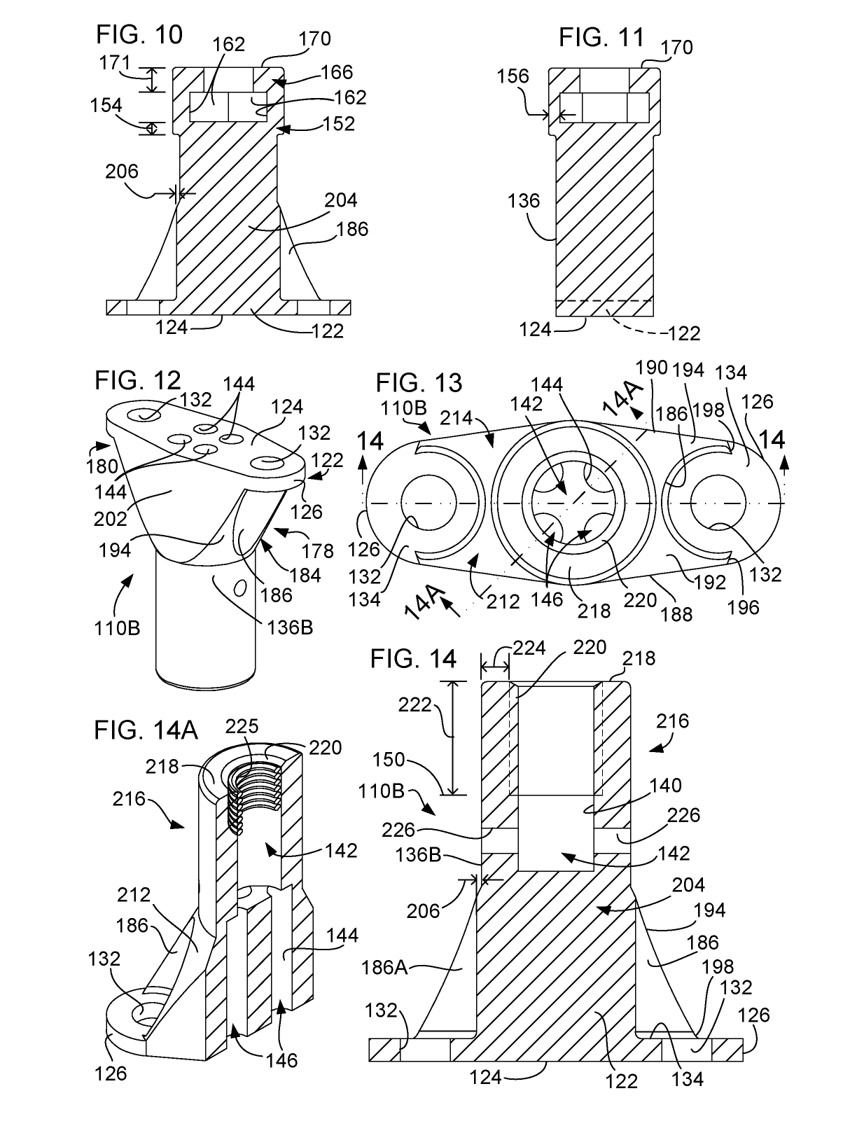

The spacer 110 includes a fastener support 148. The fastener support 148 is integral, fixed, mounted, attached or otherwise supported on an end portion 150 of the spacer body 136. As used herein, “fastener support” includes any structure, device, configuration, or implementation that supports a fastener element. In the present example, the fastener support 148 contains a portion of a first fastener element within the fastener support 148. The fastener support is configured to support the first fastener element along with the spacer body 136 to withstand the forces applied through the first fastener element under expected operating conditions that might be encountered for the particular application. The fastener support has an outer configuration that substantially conforms to the outer configuration of the spacer body 136, in the present example circular, but with a larger diameter. A lower portion 152 (FIG. 10) of the fastener support is positioned or formed adjacent the end portion 150 of the spacer body, and has an axial length 154 sufficient to provide the necessary strength in the spacer to withstand the expected forces encountered in the fastener assembly. The fastener support also has a smallest outer wall thickness 156 (FIG. 11) sufficient to withstand the torque, tensile loading and any bending moments applied to the fastener support and spacer body through the fastener. In the present example, the fastener is a hex head bolt 158 wherein the hex head 160 (FIG. 7) is retained or embedded in and supported by conforming flat surfaces 162. The smallest distance 156 extends perpendicular from a flat surface 162 to the outer circumferential surface 164 (FIG. 11). An upper portion 166 (FIG. 10) extends axially upward and encloses a portion of a shank 168 (FIG. 7) of the fastener element 158, though it need not enclose it. The upper portion 166 extends axially to an end face 170 a distance 171 sufficient to withstand any bending forces applied through the fastener element 158. An axially extending bore 172 surrounds a portion of the shank 168 where the shank extends through the upper portion 166 of the fastener support. In another example, the outer configuration of the fastener support can conform substantially to the outer-most perimeter profile of the fastener element, in the present example a hexagonal configuration.

In the present example, the fastener support positions the fastener element 158 above the spacer body 136. The fastener element does not extend through the spacer body or to the mounting surface 122. Where the fastener element 158 is formed from metal, no metal extends within the spacer body 136, where the spacer body is formed from a plastic or other non-metal material. Consequently, no part of the spacer body or interior of the spacer body is metal.

The first fastener element 158 in the present example is formed from a metal and includes the hex head 160 (FIG. 7) forming one end of the fastener element. The shank 168 includes a smooth cylindrical portion surrounded by the bore 172 in the fastener support, but may be fully threaded. The remainder of the shank is a threaded portion 174. The threaded portion 174 cooperates with a complementary fastener element, in the present example the nut 120, for supporting and securing a payload on the fastener assembly. As is described herein, other configurations of hardware for supporting and securing a payload may be incorporated in a fastener assembly.

In the example shown in FIGS. 2-11, the first fastener element 158 engages the fastener support over an engagement length 176 that is relatively small compared to the overall axial length of the fastener assembly, as well as the overall axial length of the spacer 110A. In the present example, the engagement length 176 (FIG. 7) is significantly less than 50 percent of the length of the fastener assembly and also the length of the spacer, and less than 25 percent of each. The reduced length provides improved weight reduction in the overall weight of the assembly. In the example shown in FIGS. 6-9, the engagement length 176 is about 15 percent of the fastener assembly length and about 21 percent of the spacer length. Other ratios are possible, but a 50 percent or less ratio is desirable.

In the example shown in FIGS. 2-11, the spacer 110A includes a reinforcing element and in the example two reinforcing elements 178 and 180. A reinforcing element strengthens the spacer between the spacer body and the mounting surface or mounting element. While the reinforcing elements can have configurations different from each other, the first and second reinforcing elements 178 and 180 in the present example are substantially identical to and opposite from each other, and only one will be described in detail. Specifically, the first reinforcing element 178 includes a first wall 182 and a second wall 184 extending from the corresponding surface portions of the spacer body 136 outward and downward to the upper surface 134 of mounting element 122. The first and second walls join at an approximate mid-plane of the spacer. Together, the first and second walls have interior walls combining to form a concave, substantially axially-extending interior wall 186. The interior wall 186 has a substantially semi circular shape in top profile, such as can be seen in FIG. 3.

The first and second walls 182 and 184 include respective outer wall surfaces 188 and 190. The outer wall surfaces extend substantially axially from the upper surface 134 of the mounting element 122 to respective upward-facing surfaces 192 and 194. The outer wall surfaces follow the edge profiles of the respective side edges 128 and 130 of the mounting element 122. Consequently, each reinforcing wall diverges from a respective forward point 196/198 to the front and back surfaces 200 and 202, respectively, of the spacer body. Additionally, each reinforcing wall diverges from the respective forward points along an arc toward each other and merges at a junction plane 204 (FIG. 7).

Each reinforcing wall has a thickness which varies with location. The thickness of each reinforcing wall increases from a relatively narrow portion at the forward points 196/198 to relatively large lateral thicknesses (lateral thickness being the distance from an outer wall surface 188/190 to the interior wall 186 in the direction from front to back) at the junction plane 204. Alternatively, a thickness for the reinforcing elements may be considered the greatest extending from the outer wall surface 188 to the outer wall surface 190 through the junction plane 204. Other thickness variations can be incorporated into the reinforcing elements.

Each reinforcing wall can be considered to have a thickness from the spacer body 136 outward to a radially outer-most wall portion on the reinforcing wall. This thickness will be considered a radial thickness extending from a point normal to a cylinder defined by the spacer body radially outward to a wall surface. The wall surface may be the outer wall surface 188, the outer wall surface 190, the upward-facing surface 192, the upward-facing surface 194 or the concave surface 186. For any radial thickness, the relevant thickness will be determined by the angle about the center axis 138 and the axial position along the center axis 138 closer to or farther away from the upper surface 134 of the mounting element 126. In the present example, the radial thickness is greatest adjacent the upper surface 134 for a radius terminating at or near the forward points 196 and 198. The radial thickness is zero at the front and back surfaces 200 and 202, respectively, of the spacer body. Another minimum radial thickness occurs at the junction plane 204, and the minimum thickness is constant at any axial position along the central axis 138. The minimum thickness can be seen at 206 (FIG. 10). Additionally, as seen in FIGS. 6, 7 and 10, the reinforcing walls extend downward from the cylindrical wall of the spacer body to the upper surface of the mounting element 122. The junction portions between the reinforcing walls and the upper surface of the mounting element 122 have a slight radius 207 transitioning from the reinforcing walls to the upper surface of the mounting element 122. The outer most edges of the reinforcing walls have a slight curvature or radius in side profile.

Each reinforcing wall 182/184 extends along the mounting element 122 a radial distance 208 greater than the radial distance 210 (FIG. 3) to the inner most wall of the fastener opening 132. The radial distance 208 is less than or approximately the same as the radial distance to the outer-most wall of the fastener opening 132. The radial distance 208 can be selected as desired as a function of the desired reinforcement between the spacer body and the mounting element 122.

The concave surface 186 is spaced from and encircles part of the opening 132. The spacing between the concave surface 186 and the opening 132 provides clearance for an appropriate fastener or mounting device extending into the opening 132. The spacing between the concave surface and the opening can be selected as desired.

Additional reinforcing walls 212 and 214 extend on the other side of the spacer body. The reinforcing walls 212 and 214 are substantial mirror images of the reinforcing walls 182 and 184, respectively.

In another example of a spacer assembly (FIGS. 12-14), a spacer 110B is identical in all respects to the spacer 110A except for the fastener support and a bore through part of the spacer body and the description of those identical elements are incorporated herein by reference. Identical reference numbers are applied to the elements shown in FIGS. 12-14 as are used in reference to the spacer in FIGS. 2-11 for identical elements, and the functions of those elements are identical. The remainder of the spacer 110B is described below.

The spacer body 136B in the example shown in FIGS. 12-14 may include one or more cavities, recesses or bores within or extending through the spacer body. The spacer body includes a first internal wall 140 defining a first bore 142. The first bore 142 may extend from an upper portion or upper end to an approximate mid-portion of the spacer body, but in another example described herein, the bore may extend the entire length axially of the spacer body 136B.

The first bore 142 extends axially upward from the plurality of bores 146 through a fastener support 216 to an end face 218 of the spacer. The fastener support 216 is fixed, mounted, attached or otherwise supported on the end portion 150 of the spacer body 136. In this example, the fastener support 216 contains all of a first fastener element 220. The fastener support 216 supports the first fastener element 220 along with the spacer body 136 to withstand the forces applied through the first fastener element under expected operating conditions that might be encountered for the particular application. In its outer configuration, the fastener support 216 substantially conforms to the outer configuration of the spacer body 136B in that it is substantially circular. It also has the same outer diameter as the spacer body 136B. The axial length 222 (FIG. 14) of the fastener support 216 is selected to be sufficient to provide the necessary strength in the spacer to withstand the expected forces encountered in the fastener assembly with a payload supported by the spacer assembly (e.g. bending, torque & tensile load conditions). The fastener support also has a smallest outer wall thickness 224 sufficient to withstand the torque, tensile load and any bending moment applied to the fastener support and spacer body through the fastener.

In the present example, the fastener is a helicoil insert 225 (FIG. 17; shown schematically in place in FIG. 14A) wherein the helicoil is retained by or embedded in and supported by conforming surfaces in the fastener support 216. The helicoil insert extends from one end of the fastener support to the end face 218 and is configured to receive an appropriate male fastener element such as a bolt for securing and supporting the payload 104. The helicoil insert and a bolt form first and second fastener elements combining with the spacer 110B to support the payload 104 spaced from a supporting surface such as the panel 102.

Apertures 226 are formed in the example shown in FIGS. 12-14 extending through the spacer body 136 from the first bore 142 through the outer perimeter surface of the spacer body. The apertures 226 are formed diametrically opposite each other at an axial position approximately halfway between the upper ends of the reinforcement walls and the end portion 150 of the spacer body. The apertures provide a visual indication of the length of seating of the second fastener element into the spacer. The apertures 226 can be omitted where the spacer body is formed from a transparent or translucent material.

In another example of a spacer assembly such as that shown in FIGS. 12-14, the first fastener element can take the form of a hex nut embedded in and secured against rotation by the fastener support 216. As with the helicoil insert, the hex nut cooperates with a complementary fastener element for supporting and securing a payload on the fastener assembly.

The first fastener element 220, either in the form of helicoil insert, hex nut, or other suitable engagement component, engages the fastener support over an engagement length that is relatively small compared to the overall axial length of the fastener assembly, as well as the overall length of the spacer 110B. For example, the engagement length is significantly less than 50 percent of the length of the fastener assembly and also the length of the spacer, and less than or equal to approximately 25 percent of the fastener assembly and the length of the spacer. The reduced length provides improved weight reduction in the overall weight of the assembly.

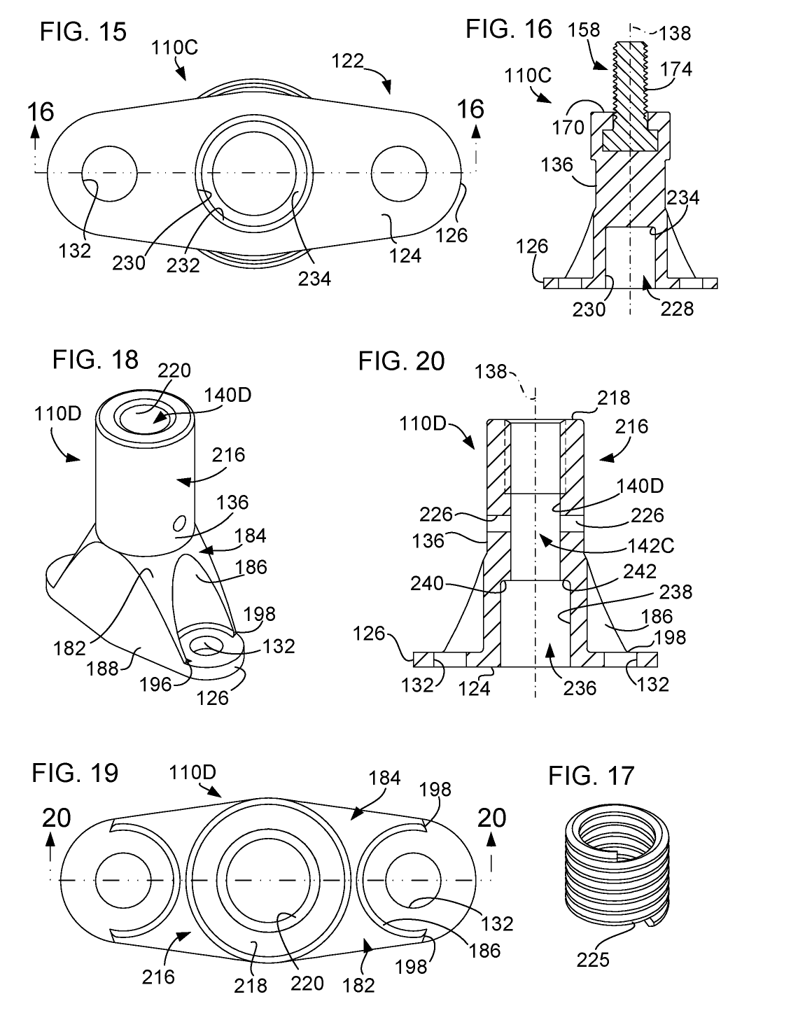

In another example of a spacer assembly such as that shown in FIGS. 2-11, a spacer assembly 110C (FIG. 15-16) is identical in all respects to the spacer 110A except for the interior of the spacer body, and the description of those identical elements are incorporated herein by reference. Identical reference numbers are applied to the elements shown in FIGS. 15-16 as are used in reference to the spacer in FIGS. 2-11 for identical elements, and the functions of those elements are identical. The remainder of the spacer 110C is described below.

In the spacer 110C, a bore 228 is formed through the bottom surface 124 and the mounting element 122 and into the interior of the spacer body 136. The bore 228 is defined by a cylindrical wall 230 having a substantially circular cross-section terminating at an end wall 234. The wall thickness of the wall surrounding the bore 228 may depend on the application for the spacer 110C. The length of the bore can extend to a level below the upper ends of the reinforcing walls 182,184, 212 and 214, to a level above the upper ends of the reinforcing walls, or at the same level. The bore 228 is positioned in the mounting element and the spacer body approximately the same as the multiple bores 146. While the bore 228 can occupy the same physical location in the spacer body as the multiple bores 146, the example of FIGS. 15-16 has the end wall 234 positioned axially between the upper and lower ends of the reinforcement walls 182 and 184. As shown in the present example, the end wall 234 occurs axially approximately ¾ of the distance from the bottom surface 124 of the mounting element to the opposite end of the reinforcing walls. Because the internal wall 140C and the bore 142C are longer than the corresponding walls in FIGS. 2-11, though otherwise identical, these components are labeled 140C and 142C, respectively.

In another example of a spacer assembly (FIGS. 18-20), a spacer 110D is identical in all respects to the spacer 110B except for the interior of the spacer body, and the descriptions of those identical elements are incorporated herein by reference. Identical reference numbers are applied to the elements shown in FIGS. 18-20 as are used in reference to the spacer in FIGS. 12-14 and FIGS. 2-11 for identical elements and the functions of those elements are identical. The remainder of the spacer 110D is described below.

In the spacer 110D, a counter bore 236 is formed through the bottom surface 124 and the mounting element 122 and into the interior of the spacer body 136. The counter bore 236 is defined by a cylindrical wall 238 having a substantially circular cross-section terminating at a small radius 240, which curves around to a shoulder 242. The shoulder forms the end of the first bore 142D. The counter bore 236 can occupy the same physical location in the spacer body as the multiple bores 146, but the example of FIGS. 18-20 has the shoulder 242 positioned axially between the upper and lower ends of the reinforcement walls 182 and 184. As shown in the present example, the shoulder 242 occurs axially approximately ¾ of the distance from the bottom surface 124 of the mounting element to the opposite end of the reinforcing walls.

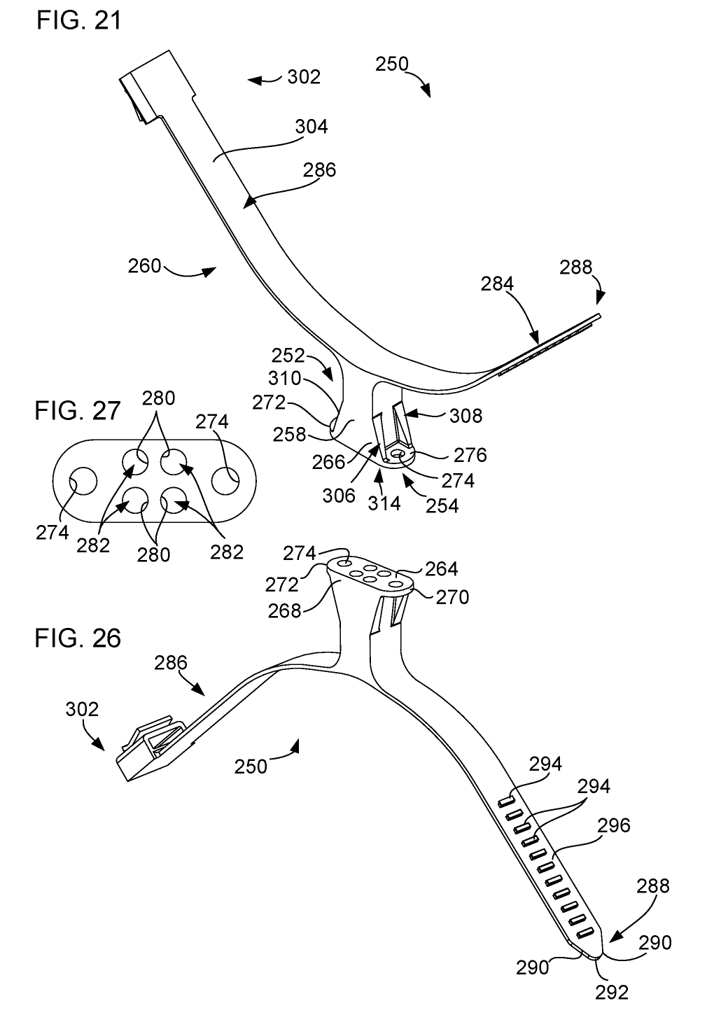

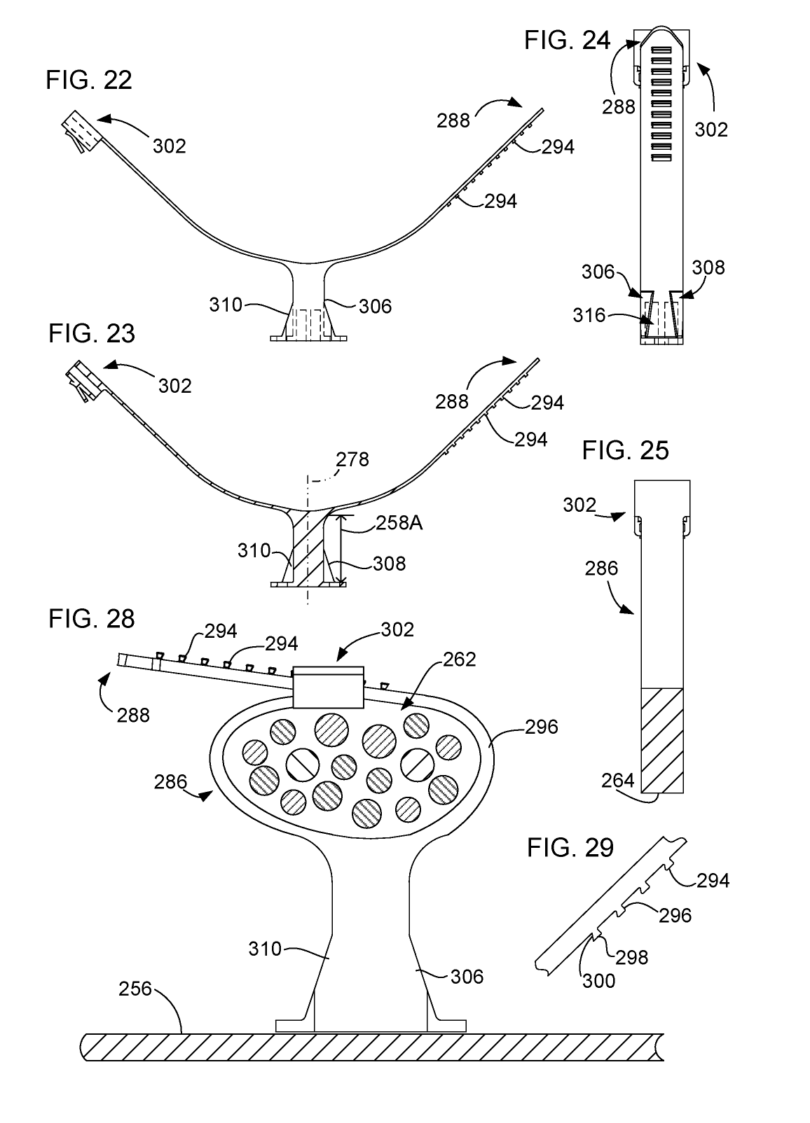

In another example of a fastener assembly, the fastener assembly 250 (FIGS. 21-29) includes a spacer 252 having a mounting element 254 for mounting the spacer 250 to a panel 256 (FIG. 28) or other support structure. The spacer includes a spacer body 258 extending in a first direction, such as axially, from the mounting element 254. In one example, the mounting element and the spacer body are formed from a non-metal material. The spacer 252 includes a fastener element 260 above the spacer body 258. The fastener element 260 accepts and supports a payload, which can be any one or more of a number of items, such as the payload 262 shown in FIG. 28, which can be cables, wires, conduit, tubing, and the like such as may be found on aircraft. The payload is supported spaced apart from the panel 256 and in the embodiment shown in FIGS. 21-29 keeps the payload relatively fixed and stationary. The fastener element 260 can be used to fasten, bundle, clamp, enclose, secure or otherwise position the payload.

The mounting element 254 is a non-metal mounting element having a substantially planar base. The base has a lower surface 264 (FIG. 26) that may be designed or configured to conform to the underlying support surface configuration. The mounting element 254 can be identical to the previously described mounting elements, or the mounting element 254 can be used in place of those on the previously described spacers. In the example shown in FIGS. 21-29, where the support surface 256 is a substantially flat planar panel, the lower surface 264 is also substantially flat. The outer perimeter of the mounting element 254 is a substantially straight-sided oval. The sides are at 266 and 268, and the semi circular end surfaces are 270 and 272. The mounting element is approximately the same thickness as the previously described mounting elements.

The mounting element includes a plurality of walls 274 defining respective openings for fasteners (not shown) for fixing the mounting element and therefore the fastener assembly to the support surface 256. The fasteners may be rivets, threaded fasteners, pins or other hardware. Other fixing means can be used, such as bonding agents, adhesives and other materials for helping to fix the mounting element 224 to the support surface 256. The mounting element includes an upper surface 276 that is substantially flat, but other surface configurations can be used.

The spacer body 258 is formed as part of, mounted to or otherwise fixed to the upper surface 276 of the mounting element 254. The body extends in a first direction such as that defined by the central axis 278 (FIG. 23) away from the upper surface 276. The spacer body 258 spaces the fastener element from the support surface 256 an amount according to the desired configuration for the final payload position. The spacer body extends a distance 258A away from the upper surface 276 and has a substantially rectangular transverse cross-section. The cross-section is substantially constant for most of the distance 258A until it approaches the fastener element 260, at which point the cross-section gradually increases. The increased cross-section helps to reliably support the fastener element 260 on the spacer body. The spacer body supports the fastener element and spaces the fastener element away from the support surface 256. Consequently, the spacer body supports the payload and spaces the payload away from the support surface 256. The outer exposed surface of the spacer body 258 may be substantially square if desired, but need not be. Other configurations are also possible.

The spacer body 258 may be solid, but in the example shown in FIGS. 21-29, the spacer body may include one or more cavities, recesses or bores within or extending through the spacer body. In the present example, the spacer body includes a plurality of walls 280 defining a respective plurality of bores 282 extending through the mounting element 254 and into a portion of the spacer body 258. Each of the bores 282 have respective central axes (not shown) extending substantially parallel to the central axis 278, and the bores 282 are distributed so as to be symmetric about the central axis 278. The bores are also arranged in this example to have their centers position on an “X” in the mounting element, rather than on the central longitudinal or transverse axes of the mounting elements. From either of the central longitudinal or transverse axes, the bore centers are located at 45 degrees, 135 degrees, 225 degrees, and 315 degrees, respectively. While the bore centers can be arranged otherwise, the “X” arrangement allows weight reduction while providing strength in the spacer body. The bores 282 are substantially right circular cylindrical. The plurality of bores form cavities without any material, and produce a lighter-weight spacer body. Where the spacer is a molded part, the plurality of bores is easily formed in part of the spacer body and through the mounting element 254. The number of bores can range from a single bore to multiple bores the number of which may be based on the bore sizes and the cross-sectional area of the spacer body. The lengths of the bores can range as a function of the spacer body's overall length, and they can be identical to each other or different. The diameters of the bores can also range as a function of the spacer body's size, as well as the wall thicknesses. The intermediate ribs or walls between adjacent bores can be configured to provide reinforcement or structural support to the spacer body, to better support the spacer against possible loading. The positions of the bores and ribs or walls can be selected to accommodate the expected loading.

In the present example, the fastener element 260 is formed from plastic or other non-metal material, while it could be made to include an appropriate flexible metal component. The fastener element 260 includes two elements mounted to, integral with or otherwise fixed to the spacer body to extend from opposite sides of the spacer body. The first fastener element 284 extends from one side of the spacer body 258 and the second fastener element 286 extends from the opposite side of the spacer body. While each of the first and second fastener elements can be otherwise different from each other, the fastener elements are identical to each other except for the respective engagement portions described herein. Each of the fastener elements are substantially flexible and resilient straps having a length sufficient to enclose the desired size of payload and a width and thickness sufficient to reliably support the payload and maintain both a secure enclosure and a secure closure.

The first fastener element 284 is formed substantially as a strap with a convergent tip 288 to make easier the insertion of the first fastener element 284 into a complementary receiver in the second fastener element 286, described below. The convergent tip 288 includes a pair of angled surfaces 290 and a rounded end 292. The first fastener element 284 includes a plurality of substantially equally spaced engagement walls 294 extending substantially normal to a portion of the outer surface 296 of the first fastener element 284. The plurality of engagement walls 294 allow selected closure of the first fastener element 284 to produce a selected encirclement of the payload. Consequently, the first fastener element 284 can accommodate different payload sizes.

Each engagement wall 294 has a substantially trapezoidal cross-section having a distal perpendicular side 296, a flat parallel top side 298 and an angled or undercut proximal side 300. The angled side 300 extends from the top side 298 to the surface of the strap of the first fastener element. The angled side 300 helps to secure the first and second fastener elements together. Other engagement wall configurations can be used.

Each of the engagement walls can engage one or more complementary surfaces in a receptacle 302 on the end of a strap portion 304 of the second fastener element 286. The receptacle 302 is a hollow enclosure having a channel extending parallel to the length of the strap portion of the second fastener element 286.

In the example shown in FIGS. 21-29, the spacer 252 includes a reinforcing element, and in the example four reinforcing elements 306, 308, 310 and 312. Each reinforcement element strengthens the spacer between the spacer body and the mounting element. While reinforcing elements can have configurations different from each other, the reinforcing elements 306-312 are substantially identical to and opposites or complements of each other. Only one will be described in detail. Specifically, the reinforcing element 306 is formed as a wall extending from the corresponding surface portion of the spacer body 258 to the upper surface 276 of the mounting element 254. The wall extends outward and downward from the spacer body to the upper surface. The wall decreases in width at a constant rate as it progresses from the spacer body axially downward to the mounting element 254. The width at any given axial position is substantially constant in the longitudinal and transverse directions. As shown in FIG. 24, the outside surface of the wall 306 is substantially straight and vertical up to the point 314 (FIG. 21) where the mounting element begins to curve. The inside surface of the wall 306 converges toward the outside wall as it approaches the upper surface 276 of the mounting element 254. Consequently, the reinforcing wall 306 diverges from a respective forward point upward to the top of the reinforcing wall where it meets the spacer body. However, at any given axial position, the wall width is substantially constant. The space 316 between the walls 306 and 308 accommodates a fastener or other element engaging the opening 274. Other thickness variations can be incorporated into the reinforcing elements, including those described previously in the examples of FIGS. 1-20.

The reinforcing element 306 extends along the mounting element 254 a longitudinal distance greater than the longitudinal distance to the inner-most wall of the fastener opening 274 (as can be visualized in FIG. 23). The longitudinal distance is less than the longitudinal distance to the outer-most wall of the fastener opening 274, and may fall approximately at the center of the opening. The longitudinal distance of the reinforcing element may be selected as desired as a function of the desired reinforcement between the spacer body and mounting element 254.

The fastener assemblies can be combined with other components to form a construction or manufacture, such as an aircraft, by mounting the fastener assembly on a substrate, panel or other supporting surface through fasteners, adhesive, a bonding material or other mounting material. The fastener assembly includes a spacer body that supports a first fastener element, either directly such as with the fastener assembly 250 (FIGS. 21-29) or through a fastener support 148 (FIGS. 2-20). A payload may be positioned on the fastener element and secured in place. Alternatively, the payload can be preassembled on multiple fastener elements by positioning the payload on multiple fastener elements (for example fastener elements 110A, 110B, 110C or 110D), either sequentially or simultaneously, followed by securing the payload on the fastener elements, either sequentially or simultaneously. In an example of pre-assembly, a payload and its securement elements can be combined, and then multiple securement elements can be placed on their respective fastener elements, for example five at a time on respective fastener elements 110A. Then, the five securement elements can be secured, for example sequentially. Alternatively, one fastener assembly can be secured with its payload portion, followed by the next securement and fastener element, and so on.

Securement may be in the form of threaded fasteners such as those shown in FIGS. 2-20, flexible fastener elements such as that shown in FIGS. 21-29, or other securement devices or means. Other methods of assembly can be used. Some other examples of securement devices can be a C-Clamp, Web Clamp, Quick Grips, Zip-Lock, Cable Ties, Velcro Tape, and Tie Downs, and they can be brackets, support blocks, retainers, or other components currently used with conventional spacers, for example.

In the present examples, the selected components of the fastener assembly are formed from the same material. In the present examples, one material is TORLON, and other poly-amide imides as well as other structural plastics can be used. Other non-metal material can also be Nylon, Ultem, Peek, Polypropylene, Fluoropolymers, and engineered resins. The material can also include fiber reinforcement or other strengthening materials. Such Ultem and Torlon materials can contain a percentage of glass or carbon or reinforcement fill which gives additional strength to the material. The assembly of FIGS. 21-29 can be formed of all structural plastic, and the mounting elements, spacer bodies and supports of FIGS. 2-20 can be formed of all structural plastic. Some or all of the fastener assembly can be formed from metal as well, incorporating one or more of the features described 10 herein. Other combinations are possible.

The fastener assembly of FIGS. 21-29 can be formed entirely of the same material, can be a monolithic component, and can be molded from the same material, or different materials. Additionally, the fastener assemblies of FIGS. 1-20 can also be formed from the same material, or all from the same material but the first and second fastener elements, such as the bolt and nut, which may be metal. When all the same material, they can be monolithic structures, and they can be molded from the same material, or different materials. When the first fastener elements are a different material from the fastener support, the first fastener element can be molded in place in the fastener support.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

What is claimed is:

1. A spacer for mounting on an aircraft surface, the spacer comprising:
a non-metal mounting surface for mounting the spacer to the aircraft surface;
a non-metal spacer body extending in a first direction from the mounting surface;
a fastener support above the spacer body;
a fastener element fixed and embedded in the fastener support above the spacer body and wherein no fastener element extends through the spacer body to the mounting surface.

2. The spacer of claim 1 wherein the fastener element is a bolt.

3. The spacer of claim 2 wherein the bolt has a head with surfaces helping to limit rotation in the fastener support.

4. The spacer of claim 3 wherein the bolt has a hex head embedded in the support.

5. The spacer of claim 2 wherein the fastener element is a nut.

6. The spacer of claim 1 further including a wall defining an opening for a fastener for fixing the mounting surface to the aircraft surface and reinforcing walls on each side of the opening.

7. The spacer of claim 6 wherein the reinforcing walls include a concave surface extending about the opening.

8. The spacer of claim 6 further including a second wall defining a second opening and having a concave reinforcing wall extending around the second opening and between the body and the mounting surface.

9. The spacer of claim 1 wherein the body includes an outer wall having a first cross sectional area and wherein the support includes a support outer wall having a second cross sectional area greater than the first cross sectional area.

10. The spacer of claim 1 wherein the fastener element is embedded such that separation of the fastener element and the support is substantially prevented.

11. The spacer of claim 1 wherein the spacer body and the support extend axially a first distance and the fastener element is engaging the fastener support axially at a second distance less than the first distance.

12. The spacer of claim 11 wherein the second distance is less than approximately 50 percent of the first distance.

13. The spacer of claim 11 wherein the second distance is less than approximately 25 percent of the first distance.

14. The spacer of claim 1 wherein the body has a cross-sectional area that is substantially constant in an axial direction over a first distance.

15. The spacer of claim 1 wherein the fastener support has an external perimeter that has a substantially uniform cross-section.

16. The spacer of claim 1 wherein the fastener support has a circular perimeter.

17. The spacer of claim 16 wherein the fastener body has a circular perimeter.

18. The spacer of claim 1 wherein the fastener support has a non-circular perimeter.

19. The spacer of claim 16 wherein the fastener body has a non-circular perimeter.

20. The spacer of claim 1 wherein the fastener body includes a lower portion adjacent to the mounting surface and wherein the first portion includes at least a first bore extending within at least part of lower portion.

21. The spacer of claim 20 further including a second bore and wherein the at least first bore extends between the second bore and the mounting surface.

22. The spacer of claim 20 further including a second bore spaced apart from the at least first bore and extending a length approximately the same as a length of the at least first bore.

23. The spacer of claim 22 further including a third and fourth bore is spaced apart from the at least first bore and extending a length approximately the same as a length of the at least first bore.

24. The spacer of claim 22 including a further bore and wherein the first and second bores open into the further bore.

25. The spacer of claim 24 wherein the further bore is centered on an axis of the spacer and wherein each of the first and second bores are not centered on the axis.

26. A spacer for mounting on an aircraft surface, the spacer comprising:
a non-metal support surface for supporting the spacer on the aircraft surface;
a non-metal spacer body extending away from the support surface;
at least one reinforcement wall extending between the body and the support surface;
a support for a fastener element on a side of the body opposite the support surface; and
a fastener element in the support for receiving a complementary fastener element.

27. The spacer of claim 26 wherein the support surface is substantially planar.

28. The spacer of claim 27 wherein the support surface includes a first wall defining an opening for receiving a fastener.

29. The spacer of claim 28 including a fastener extending through the opening and fixed to the aircraft surface.

30. The spacer of claim 26 wherein the spacer body is substantially non-circular.

31. The spacer of claim 26 wherein the spacer body is substantially circular.

32. The spacer of claim 31 wherein the spacer body includes at least one bore.

33. The spacer of claim 32 wherein the at least one bore is coaxial with an axis of the spacer.

34. The spacer of claim 32 wherein the at least one bore includes an axis substantially parallel to and spaced apart from the spacer axis.

35. The spacer of claim 34 further including additional bores in the body.

36. The spacer of claim 32 wherein the at least one bore extends through the support surface.

37. The spacer of claim 32 wherein the at least one bore has a substantially circular cross-section.

38. The spacer of claim 32 wherein the at least one bore extends from the support through the spacer body and through the support surface.

39. The spacer of claim 38 further including a counter bore extending through the support surface and a portion of the spacer body.

40. The spacer of claim 26 wherein the spacer body includes a plurality of bores.

41. The spacer of claim 26 wherein the at least one reinforcement wall includes a concave surface adjacent the fastener element.

42. The spacer of claim 41 wherein the concave surface is substantially semi circular.

43. The spacer of claim 41 wherein the at least one reinforcement wall includes an outer surface, wherein the support surface includes an edge and wherein the outer surface extends along the edge.

44. The spacer of claim 41 wherein the at least one reinforcement wall extends upward and contacts the spacer body along an outer surface of the spacer body.

45. The spacer of claim 41 wherein the at least one reinforcement wall includes a plurality of reinforcement portions between the concave surface and a portion of the spacer body.

46. The spacer of claim 45 wherein the plurality of reinforcement portions extend between opposite edges of the support surface and around a portion of a perimeter of the spacer body.

47. The spacer of claim 46 further including a second plurality of reinforcement portions on a side of the spacer body opposite the first plurality of reinforcement portions.

48. The spacer of claim 26 wherein the at least one reinforcement wall extends axially along an outside surface of the spacer body and angles downward to an upper surface of the support surface.

49. The spacer of claim 48 wherein the at least one reinforcement wall extends along an edge of the support surface.

50. The spacer of claim 49 wherein the at least one reinforcement wall extends away from the spacer body along the support surface farther from the spacer body than a beginning of the fastener element extends from the spacer body.

51. A spacer for mounting on an aircraft surface, the spacer comprising:
a non-metal support surface for supporting the spacer on the aircraft surface;
a non-metal spacer body extending away from the support surface;
at least one reinforcement wall extending between the body and the support surface;
a flexible securement on the body and having first and second securement portions securable to each other for forming a closed loop.

52. The spacer of claim 51 further including a mounting element in the support surface and a wall on each side of the mounting element.

53. The spacer of claim 51 further including a pair of mounting elements on opposite sides of the body and respective reinforcement walls extending between the body and the support surface.

54. The spacer of claim 51 further including a saddle at an end of the body opposite the support surface and a first flexible securement element extending from a first portion of the saddle and a second securement element extending from a second portion of the saddle.

55. The spacer of claim 54 wherein the first and second flexible securement elements extend from opposite sides of the saddle from each other.

56. The spacer of claim 54 wherein the first and second securement elements extend to respective first and second securement portions and wherein the first and second securement portions engage each other to form a closed loop.

57. The spacer of claim 51 wherein the spacer is formed from a polyamide imide.

58. The spacer of claim 51 wherein the body has a non-circular cross-section.

59. The spacer of claim 51 wherein the body has a rectangular cross-section.

60. The spacer of claim 51 wherein the body includes at least one axially extending cavity.

61. The spacer of claim 51 further including a plurality of channels internal to the body.

62. The spacer of claim 61 wherein the channels are parallel to each other.

63. The spacer of claim 61 wherein channels are arranged within a rectangle.

64. The spacer of claim 61 wherein each of the plurality of channels have a closed end.

65. The spacer of claim 64 wherein each of the closed channels opens at the support surface.

66. The spacer of claim 51 wherein the first securement portion includes spaced apart projections for engaging the second securement portion.

67. The spacer of claim 66 wherein the second securement portion includes an engagement surface for engaging the spaced apart projections.

68. The spacer of claim 51 wherein the body includes a base portion having a first width, an intermediate portion having a second width less than the first width.

69. The spacer of claim 68 wherein the body includes an upper portion supporting the flexible securement having a third width larger than the second width.

70. A method of assembling a payload on a spacer in aircraft, the method comprising:
securing a first fastener assembly having at least one non-metal component on an aircraft surface;
positioning a payload on an end portion of the fastener assembly spaced from the aircraft surface; and
securing the payload to the end portion of the fastener assembly.

71. The method of claim 70 wherein securing the assembly on aircraft surface includes securing a spacer assembly having a non-metal spacer to the aircraft surface.

72. The method of claim 71 wherein securing the assembly on aircraft surface includes securing the assembly on aircraft surface so that no metal component passes through the length of the spacer assembly.

73. The method of claim 70 wherein securing the payload includes securing the payload through a flexible strap.

74. The method of claim 70 wherein securing the payload includes securing the payload using a strap that is integral with the spacer.

75. The method of claim 70 wherein securing the assembly to the aircraft surface includes securing a spacer element having a hollow cavity to the aircraft surface.

76. The method of claim 70 further including positioning the payload on an end portions of a plurality of fastener assemblies prior to securing the payload on the end portions of the plurality of fastener assemblies.

77. A method of assembling a payload on an aircraft, the method comprising:
positioning a plurality of securement portions on a payload;
placing the plurality of securement portions on respective fastener assemblies spaced from a surface on the aircraft; and
securing the plurality of securement portions on their respective fastener assemblies after all of the plurality of securement portions are placed on the respective fastener assemblies.

78. The method of claim 77 wherein positioning a plurality of securement portions on a payload includes placing a plurality of clamps on the payload.

79. The method of claim 77 wherein placing the plurality of securement portions on respective fastener assemblies includes placing the plurality of securement portions on respective male fasteners spaced from the surface of the aircraft.

80. The method of claim 79 wherein securing the plurality of securement portions includes placing a nut on the respective male fasteners.

81. The method of claim 77 further including securing spacers with the respective fastener assemblies onto the surface of the aircraft.

82. A method of assembling a payload on an aircraft, the method comprising:
preassembling a plurality of securement portions on a payload;
placing the plurality of securement portions on respective fastener assemblies spaced from and supported by a surface on the aircraft; and
securing the plurality of securement portions on their respective fastener assemblies after all of the plurality of securement portions are placed on the respective fastener assemblies.

83. The method of claim 82 wherein placing the plurality of securement portions on the respective fastener assemblies includes placing two securement portions on respective fastener assemblies.

84. The method of claim 82 wherein placing the plurality of securement portions on the respective fastener assemblies includes placing five securement portions on respective fastener assemblies.
